(19) United States
(12) Patent Application Publication
(10) Pub. No.: US 2017/0086100 A1
(43) Pub. Date: Mar. 23, 2017

(54) Managing Tune-Away Performance During An Ongoing Voice Communication Session

(71) Applicant: QUALCOMM Incorporated, San Diego, CA (US)

(72) Inventors: Sagar, Hyderabad (IN); Venkata Appala Naidu Baddadi, Hyderabad (IN); Appala Naga Raju Bodduru, Hyderabad (IN)

(21) Appl. No.: 14/862,837

(22) Filed: Sep. 23, 2015

(51) Int. Cl. H04W 36/00; H04W 24/08; H04W 36/36

(52) U.S. Cl. CPC H04W 36/0011; H04W 36/36; H04W 24/08

(57) ABSTRACT

Embodiments include systems and methods for managing a tune-away from a first subscription to a second subscription in a multi-subscription multi-standby communication device during an ongoing voice communication session on the first subscription. A device processor may perform a tune-away from the first subscription to the second subscription. The device processor may determine whether a data transmission over the first subscription was missed during the tune-away. The device processor may calculate a data loss rate in response to determining that a data transmission of the first subscription was missed during the tune-away. The device processor may determine whether the data loss rate is greater than a data loss threshold, and the device processor may block a next tune-away in response to determining that the data loss rate is greater than the data loss threshold. In some embodiments, the first subscription may send a request to create a tune-away gap.

### BACKGROUND

A multi-subscription multi-standby (MSMS) communication device may include two or more subscriber identity module (SIM) cards, each of which may be associated with a different service provider subscription. MSMS communication devices may be provided in a range of configurations, including a dual-subscription dual-standby (DSDS) configuration, in which two SIMs share a set of receive (Rx) circuitry (referred to as an “Rx chain”). MSMS communication devices may also be configured to utilize a variety of radio access technology (RAT) protocols (e.g., 3GPP Long Term Evolution (LTE), Global System for Mobility (GSM), and Wideband Code Division Multiple Access (WCDMA). A SIM and/or subscription may be associated with one or more RATs.

An MSMS communication device may be configured as a dual receive (DR) device (DR-MSMS), in which the MSMS communication device has a radio frequency (RF) resource (e.g., a transceiver) that includes one set of transmit (Tx) circuitry (referred to as a “Tx chain”) and two (or more) Rx chains. While a DR-MSMS device may typically only transmit using a single subscription at a time because the DR-MSMS communication device includes one Tx chain, the DR-MSMS communication device may simultaneously receive signals using two (or more) different subscriptions.

A DR-MSMS communication device may employ a “tune-away” procedure by tuning one Rx chain away to a second network in a second cell (e.g., of a second subscription) for a short time, and then tuning the Rx chain back to a first network (e.g., of the first subscription). This tune-away procedure may allow the MSMS communication device to monitor for pages or other indications of incoming messages or data received on the second subscription. However, tuning away to the second network may decrease the throughput of communications between the MSMS communication device and the first subscription, and may degrade the quality of an active communication session over the first subscription.

### SUMMARY

Various embodiments include methods implemented on multi-subscription multi-standby communication devices for managing a tune-away from a first subscription to a second subscription during an ongoing voice communication session on the first subscription. Various embodiments may include performing a tune-away from the first subscription to the second subscription, determining whether data was transmitted to the multi-subscription multi-standby communication device over the first subscription during the tune-away, calculating a data loss rate in response to determining that data was transmitted to the multi-subscription multi-standby communication device over the first subscription during the tune-away, determining whether the data loss rate is greater than a data loss threshold, and blocking a next tune-away in response to determining that the data loss rate is greater than the data loss threshold.

In some embodiments, blocking a next tune-away in response to determining that the data loss rate is greater than the data loss threshold may include setting a tune-away block indicator to block the next tune-away in response to determining that the data loss rate is greater than the data loss threshold. Some embodiments may further include permitting a next tune-away in response to determining that the data loss rate is not greater than the data loss threshold.

Some embodiments may further include monitoring a control channel of the first subscription during the tune-away in which determining whether data was transmitted to the multi-subscription multi-standby communication device over the first subscription during the tune-away is based on the monitoring of the control channel of the first subscription. In some embodiments, blocking a next tune-away in response to determining that the data loss rate is greater than the data loss threshold may include setting a tune-away block indicator to block the next tune-away in response to determining that the data loss rate is greater than the data loss threshold. Some embodiments may further include determining whether the tune-away block indicator is set to block the next tune-away, and blocking the next tune-away in response to determining that the tune-away block indicator is set to block the next tune-away.

The various methods may also include determining a paging message timing of the second subscription, determining whether there is an upcoming overlap between the voice communication session and a paging message on the second subscription, calculating a timing of a tune-away gap, sending a request using the first subscription to create the tune-away gap, and performing a tune-away from the first subscription to the second subscription during the tune-away gap. In some embodiments, calculating a timing of a tune-away gap may further include calculating a duration of the tune-away gap.

Some embodiments may further include determining whether an indication of a creation of the tune-away gap is received, and determining whether there is an upcoming overlap between the tune-away gap and a paging message on the second subscription, in which performing the tune-away from the first subscription to the second subscription during the tune-away gap may include performing the tune-away from the first subscription to the second subscription during the tune-away gap in response to determining that there is an upcoming overlap between the tune-away gap and a paging message on the second subscription.

Some embodiments may further include incrementing a tune-away gap request counter after sending the request using the first subscription to create the tune-away gap. Some embodiments may further include determining whether the tune-away gap request counter is greater than a tune-away gap counter threshold, and sending another request to create the tune-away gap in response to determining that the tune-away gap request counter is not greater than the tune-away gap counter threshold.

Various embodiments further include a mobile computing device having a memory, a radio frequency (RF) resource, and a processor coupled to the memory and the RF resource and configured with processor executable instructions to perform operations of the methods described above. Various embodiments include a mobile computing device having means for performing functions of the methods described above. Various embodiments include a non-transitory processor-readable storage medium having stored thereon processor-executable instructions configured to cause a processor of a mobile computing device to perform operations of the methods described above.

### BRIEF DESCRIPTION OF THE DRAWINGS

The accompanying drawings, which are incorporated herein and constitute part of this specification, illustrate exemplary embodiments. Together with the general description given above and the detailed description given below, the drawings serve to explain features of various embodiments, and not to limit various embodiments.

FIG. 1 is a component block diagram of a communication system suitable for use with various embodiments.

FIG. 2 is a component block diagram of a multi-subscription multi-standby communication device according to various embodiments.

FIG. 3 is a process flow diagram illustrating a method for managing a tune-away from a first network to a second network during an ongoing voice communication session on the first network according to various embodiments.

FIG. 4 is a process flow diagram illustrating another method for managing a tune-away from a first network to a second network during an ongoing voice communication session on the first network according to various embodiments.

FIG. 5 is a component block diagram of a multi-subscription multi-standby communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods implemented in multi-subscription multi-standby communication devices that enable decoding of system information of a plurality of communication networks received by a processor of a multi-subscription multi-standby communication device in a manner that reduces the time required to receive the system information of all communication networks.

The term “multi-subscription multi-standby (MSMS) communication device” is used herein to refer to any one or all of cellular telephones, smartphones, personal or mobile multi-media players, personal data assistants, laptop computers, tablet computers, smartbooks, palmtop computers, wireless electronic mail receivers, multimedia Internet enabled cellular telephones, wireless gaming controllers, and similar electronic devices and portable computing platforms that include a programmable processor, a memory, and a shared radio frequency (RF) resource configured to support two or more subscriptions. Various embodiments may be particularly useful in any communication devices that can support multiple wireless wide area network subscriptions and receive cell broadcasts via the shared RF resource.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a multi-subscription multi-standby communication device and the multi-subscription multi-standby communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

References to “first network,” “first subscription,” “second network,” and “second subscription” are arbitrary and are used to refer to two or more subscriptions/networks generally because at any given time either subscription/network may be in an active mode (on an active voice or data call) or a standby mode, and all subscriptions/networks may need to monitor for system information (e.g., for network system information block (SIB) transmissions). For example, at one time the multi-subscription multi-standby communication device may conduct an active communication session using a first subscription with a first network (and thus a “first subscription) while a second subscription with a second network is in a standby mode (and thus a “second” subscription), and at a later time the second subscription may enter an active data call (becoming the “first” subscription) and the first subscription may enter the standby mode (becoming the “second” subscription). Also, references to “first” and “second” subscriptions and networks are not intended to imply that the embodiments are limited to two subscriptions sharing one RF resource, because three or more subscriptions may share one RF resource provided that only one subscription can use the RF resource at a time. Third and fourth subscriptions would behave similar to a second subscription. Therefore, in the interest of brevity, operations of subscriptions in the standby mode that share the RF resource during tune-away periods are described generally with reference to the “second” subscription.

MSMS communication devices can communicate with two or more cells of a wireless network. MSMS communication devices may allow two or more network interfaces or subscriber identity modules (SIMs) to share a single receiver/transmitter chain, such as a dual SIM dual standby (DSDS) communication device. However, the receiver/transmitter chain in such devices can only tune to a single network at a time. Examples of DSDS communication devices include a DSDS communication device that supports LTE and another radio access technology (e.g., GSM). Such LTE+ another radio access technology are referred to as “L+X” RAT capable devices. A radio in some DSDS communication devices may include one shared transmitter chain (“Tx chain”) but two receiver chains (“RX chains”) enabling operations in the receive diversity mode for improved reception, or operations in a concurrent standby mode in which two (or more) different communication networks are monitored (e.g., for pages and similar messages) simultaneously.

A Voice Over LTE (VoLTE) call may use both receive chains of a dual-receive-capable MSMS communication device to operate in the receive diversity mode in order to provide the user with better reception. Due to the improvement in reception offered by receive diversity, current dual-receive-capable MSMS devices disable the capacity to perform a tune-away to a second subscription (e.g., a GSM tune-away) during a VoLTE call. As a result, the MSMS communication device may miss an incoming page on the second subscription, and thus may fail to answer an incoming call request.

Various embodiments provide methods implemented by a processor in a multi-subscription multi-standby communication device for managing a tune-away from a first subscription to a second subscription during an ongoing voice communication session on the first subscription to better balance the competing priorities of providing quality reception on a first subscription enable by received diversity while monitoring for pages on a second subscription.

In some embodiments, the MSMS communication device may enable a tune-away to a radio access technologies such as GSM on a second subscription during an ongoing VoLTE communication session. In some embodiments, the MSMS communication device may include a communication device that supports communication using LTE on a first subscription and another radio access technology on a second subscription (e.g., a DSDS L+X RAT capable communication device).

In various embodiments, a processor of the MSMS communication device (i.e., a “device processor”) may permit the tune-away from the first subscription to the second subscription when a communication link of the first subscription is of sufficient quality to perform the tune-away without substantially degrading the performance or quality of an ongoing voice communication session on the first subscription. In some embodiments, the device processor may permit a tune-away to monitor GSM paging messages when a VoLTE downlink is of sufficient quality to permit the tune-away without substantial degradation of the voice communication session. In some embodiments, the device processor may monitor a control channel of the first subscription (e.g., a physical downlink control channel (PDCCH) of the first subscription) during the first tune-away to determine whether downlink data (i.e., data of the voice communication session) is scheduled (e.g., transmitted) on the first subscription during the performance of the first tune-away. In various embodiments, the device processor may tune away one Rx chain to the second subscription while continuing the voice communication session using a second Rx chain during the tune-away.

In some embodiments, the device processor may dynamically determine whether a next tune-away may degrade the voice communication session below a threshold level. For example, in such embodiments, the device processor may calculate a data loss rate caused by a first tune-away. The device processor may estimate or calculate the data loss rate based on data that is missed from the voice communication session during the tune-away.

The device processor may also determine whether the data loss rate is greater than or equal to a data loss threshold. If the calculated data loss rate exceeds the data loss threshold, the device processor may block the next-scheduled tune-away to the second subscription. However, if the calculated data loss rate does not exceed the data loss threshold, a device processor may permit the next tune-away to the second subscription. In some embodiments, this process may be repeated for each paging cycle of the second subscription, thereby enabling opportunistic tune-aways as downlink transmissions and/or link quality permit. Thus, the device processor may enable some monitoring of paging messages on the second subscription when conditions permit, rather than disabling all tune-aways to the second subscription.

In various embodiments, the device processor may request a gap in the ongoing voice communication session in order to perform the tune-away to the second subscription. For example, the device processor may request a gap in an ongoing VoLTE communication session in order to perform the tune-away to monitor GSM paging messages on the second subscription.

In some embodiments, the device processor may determine a timing of paging messages on the second subscription while conducting a voice communication session on the first subscription. For example, the device processor may use system information (e.g., system information block (SIB) or master information block (MIB) messages) from the second network to determine the page timing of the second subscription.

In some embodiments, the device processor may calculate a timing and a duration of gap that the device processor may request in the transmission of downlink data on the first subscription (a “tune-away gap”). The device processor may then send a request to the first network to create the tune-away gap. The device processor may perform the tune-away to the second subscription during the tune-away gap that is created on the first subscription. In some embodiments, the device processor may monitor the second subscription for paging messages during the tune-away gap. In some embodiments, the device processor may maintain the ongoing voice communication session while monitoring the second subscription.

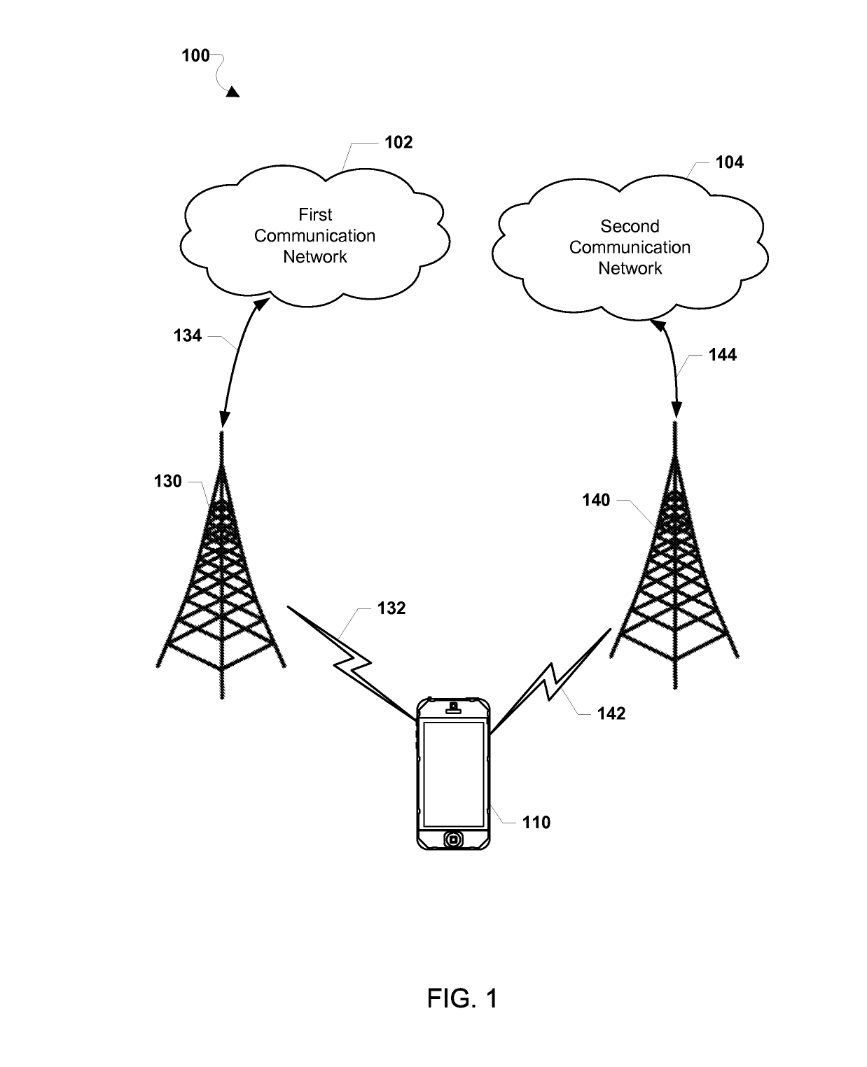

Various embodiments may be implemented within a variety of communication systems 100, such as systems that include at least two mobile communication networks, an example of which is illustrated in FIG. 1. A first communication network 102 and a second communication network 104 each may include a plurality of cellular base stations (e.g., a first base station 130 and a second base station 140). A multi-subscription multi-standby communication device 110 may communicate with the first communication network 102 through a communication link 132 to the first base station 130. The multi-subscription multi-standby communication device 110 may also communicate with the second communication network 104 through a communication link 142 to the second base station 140. The first base station 130 may communicate with the first communication network 102 over a wired or wireless communication link 134, and the second base station 140 may communicate with the second communication network 104 over a wired or wireless communication link 144. The communication links 134, 144 may include fiber optic backhaul links, microwave backhaul links, and other similar communication links.

Each of the communication networks 102 and 104 may support communications using one or more radio access technologies, and each of the communication links 132, 134, 142, 144 may include cellular connections that may be made through two-way wireless communication links using one or more RATs. Examples of RATs may include LTE, Worldwide Interoperability for Microwave Access (WiMAX), Code Division Multiple Access (CDMA), Time Division Multiple Access (TDMA), WCDMA, GSM, and other RATs. While the communication links 132, 134, 142, 144 are illustrated as single links, each of the communication links may include a plurality of frequencies or frequency bands, each of which may include a plurality of logical channels. Additionally, each of the communication links 132, 134, 142, 144 may utilize more than one RAT.

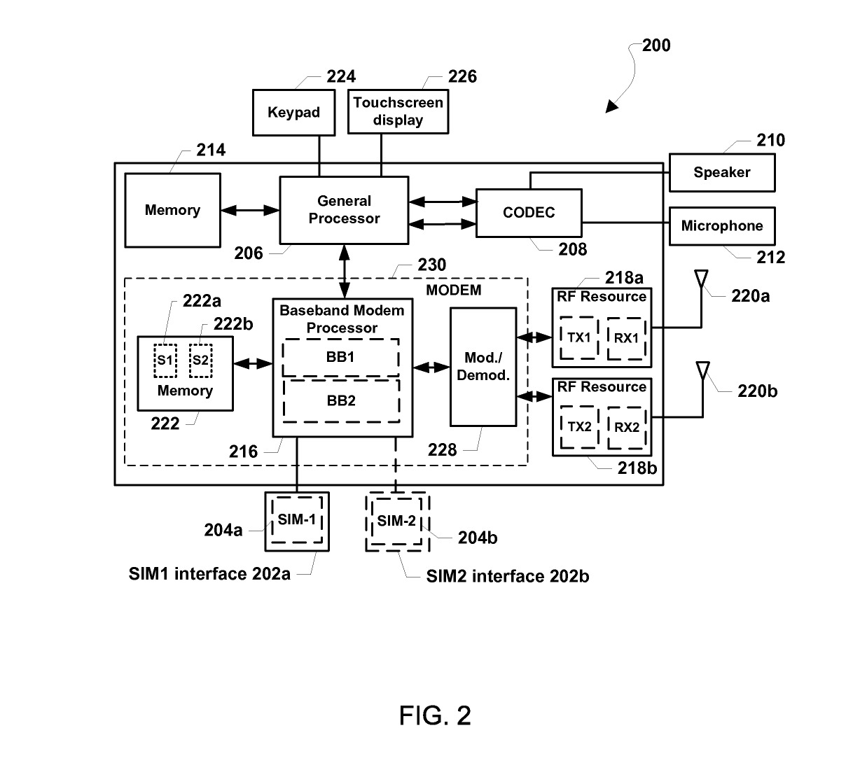

FIG. 2 is a component block diagram of an MSMS communication device 200 suitable for implementing various embodiments. With reference to FIGS. 1 and 2, in various embodiments, the MSMS communication device 200 may be similar to MSMS communication device 102. The MSMS communication device 200 may include a first SIM interface 202a, which may receive a first identity module SIM-1 204a that is associated with a first subscription. The MSMS communication device 200 may optionally also include a second SIM interface 202b, which may receive a second identity module SIM-2 204b that is associated with a second subscription.

A SIM in various embodiments may be a Universal Integrated Circuit Card (UICC) that is configured with SIM and/or USIM (Universal Subscriber Identity Module) applications, enabling access to, for example, GSM and/or Universal Mobile Telecommunications System (UMTS) networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

The MSMS communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The general-purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to one or more RF resources 218a, 218b for transmission. The modulator/demodulator 228 may also extract an information-bearing signal from a modulated carrier wave received from the one or more RF resources 218a, 218b, and may provide the demodulated signal to the baseband modem processor 216. The modulator/demodulator 228 may be or include a digital signal processor (DSP).

The baseband modem processor 216 may read and write information to and from the memory 222. The memory 222 may also store instructions associated with a protocol stack, such as protocol stack S1 222a and protocol stack S2 222b. The protocol stacks S1 222a, S2 222b generally include computer executable instructions to enable communication using a radio access protocol or communication protocol. Each protocol stack S1 222a, S2 222b typically includes network protocol layers structured hierarchically to provide networking capabilities. The modem 230 may include one or more of the protocol stacks S1 222a, S2 222b to enable communication using one or more RATs. The protocol stacks S1 222a, S2 222b may be associated with a SIM card (e.g., SIM-1 204a, SIM-2 204b) configured with a subscription. For example, the protocol stack S1 222a and the protocol stack S2 222b may be associated with the SIM-1 204a. The illustration of only two protocol stacks S1 222a, S2 222b is not intended as a limitation, and the memory 222 may store more than two protocol stacks (not illustrated).

Each SIM and/or RAT in the MSMS communication device 200 (e.g., SIM-1 204a, SIM-2 204b) may be coupled to the modem 230 and may be associated with or permitted to use an RF resource. The term “RF resource chain” may be used to refer to all of the circuitry used to send and receive RF signals, which may include the baseband modem processor 216 that performs baseband/modem functions for communicating with/controlling a RAT, one or more radio units including transmitter and receiver components that are shown as RF resources 218a, 218b (e.g., in FIG. 2), one or more of the wireless antennas 220a, 220b, and additional circuitry that may include one or more amplifiers and radios. The term “Rx chain” may be used to refer to a portion of an RF resource chain that may receive RF signals, and the term “Tx chain” may be used to refer to a portion of an RF resource that may transmit RF signals. In some embodiments, an RF resource may share a common baseband modem processor 216 (i.e., a single device that performs baseband/modem functions for all RATs on the MSMS communication device). In some embodiments, each RF resource may include the physically or logically separate baseband processors (e.g., BB1, BB2).

The RF resources 218a, 218b may include transceivers associated with one or more RATs and may perform transmit/receive functions for the MSMS communication device 200 on behalf of their respective RATs. The RF resources 218a, 218b may include separate transmit and receive circuitry. In some embodiments, the RF resource 218b may include only receive circuitry. The RF resources 218a, 218b may each be coupled to a wireless antenna (e.g., the first wireless antenna 220a and the second wireless antenna 220b). The RF resources 218a, 218b may also be coupled to the modem 230 (e.g., via the modulator/demodulator 228, the baseband modem processor 216, or another component).

In some embodiments, the general-purpose processor 206, memory 214, baseband processor(s) 216, and the RF resources 218a, 218b may be included in the MSMS communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the MSMS communication device 200 may include, but are not limited to, a keypad 224 and a touchscreen display 226.

In some embodiments, the keypad 224, the touchscreen display 226, the microphone 212, or a combination thereof may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the MSMS communication device 200 to enable communication between them.

Functioning together, the two SIMs 204a, 204b, the baseband processor(s) 216, RF resources 218a, 218b and the antennas 220a, 220b may enable communications on two or more RATs. For example, one SIM, baseband processor and RF resource may be configured to support two different RATs. In other embodiments, more RATs may be supported on the MSMS communication device 200 by adding more SIM cards, SIM interfaces, RF resources, and antennas for connecting to additional mobile networks.

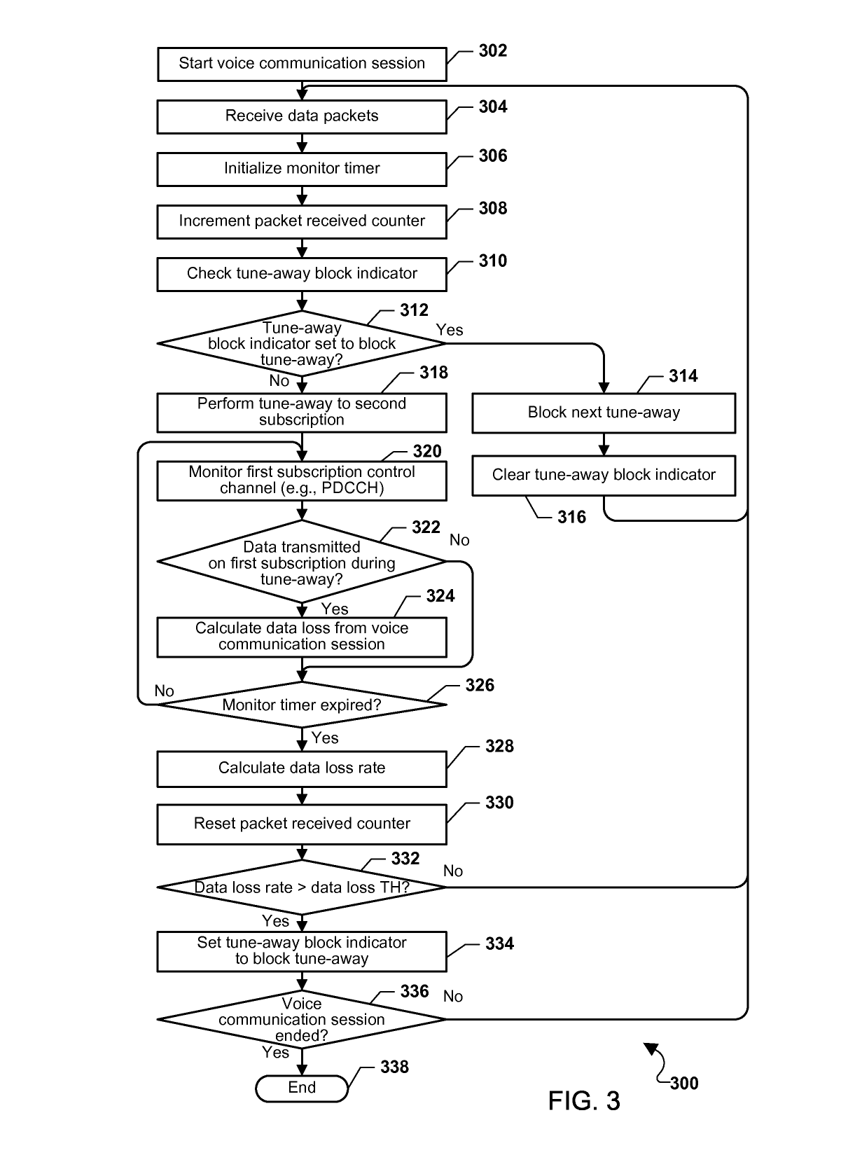

FIG. 3 illustrates a method 300 for managing a tune-away from a first subscription to a second subscription in a multi-subscription multi-standby communication device during an ongoing voice communication session on the first subscription according to some embodiments. With reference to FIGS. 1-3, the method 300 may be implemented by a device processor (e.g., the general-purpose processor 206, the baseband processor 216, a separate controller, and/or the like) of the multi-subscription multi-standby communication device (e.g., the multi-subscription multi-standby communication device 102, 200).

In block 302, the MSMS communication device may start a voice communication session on a first subscription. In some embodiments, the voice communication session may include a VoLTE communication session. In block 304, the MSMS communication device may receive data packets of the voice communication session.

In block 306, the device processor may initialize a monitor timer. The device processor may use the monitor timer to determine a time at which the device processor may calculate a data loss from the voice communication session. In block 308, the device processor may increment a packet received counter. In some embodiments, the device processor may increment the packet received counter after successfully decoding a data packet (as may be received, for example, on a data bearing channel or a traffic channel, such as a Physical Downlink Shared Channel (PDSCH)). The device processor may use a value of the packet received counter to determine a data loss from the voice communication session.

In block 310, the device processor may check a tune-away block indicator. In determination block 312, the device processor may determine whether the tune-away block indicator is set to block an upcoming tune-away from the first subscription to the second subscription.

In response to determining that the tune-away block indicator is set to block the tune-away (i.e., determination block 312=“Yes”), the device processor may block the next tune-away in block 314, and clear the tune-away block indicator in block 316. For example, the device processor may set the tune-away block indicator to permit an upcoming tune-away. The device processor may continue receiving data packets of the ongoing voice communication session in block 304.

In response to determining that the tune-away block indicator is not set to block the tune-away (i.e., determination block 312=“No”), the device processor may perform a tune-away to the second subscription (i.e., the device processor may perform a tune-away from the first subscription to the second subscription) in block 318. In some embodiments, the device processor may tune away one RF resource chain (or one Rx chain) of the MSMS communication device from the first subscription to the second subscription. In some embodiments, the device processor may continue to perform the ongoing voice communication session with one or more other RF resource chains (or Rx chains) of the MSMS communication device.

In block 320, the device processor may monitor a control channel (e.g., a Physical Downlink Control Channel (PDCCH)) of the first subscription to determine whether data to the MSMS communication device during tune-away. In some embodiments, the device processor may continue to conduct the ongoing voice communication session on one RF resource/Rx chain of the MSMS communication device, and the device processor may tune another RF resource/Rx chain to the second subscription. In such embodiments, the reception of data for the voice communication session may be reduced when the device processor tunes away an RF resource chain/Rx chain to the second subscription.

In determination block 322, the device processor may determine whether data is transmitted on the first subscription during the tune-away. This determination may be made based on an indication in the monitored control channel of the first subscription. The indication may include an indication that the downlink data is scheduled for transmission to the MSMS communication device during the tune-away.

In response to determining that data is not transmitted on the first subscription during the tune-away (i.e., determination block 322=“No”), the device processor may determine whether the monitor timer has expired in determination block 326.

In response to determining that data is transmitted on the first subscription during the tune-away (i.e., determination block 322=“Yes”), the device processor may calculate a data loss from the voice communication session in block 324. The data loss may include an amount of data of the voice communication session that the device processor does not receive during the tune-away to the second subscription. In some embodiments, the device processor may calculate the data loss based on Semi-Persistent Scheduling (SPS) information of the voice communication session, which may indicate a periodicity and/or an amount of information sent to the multi-subscription multi-standby communication device for the voice communication session. In some embodiments, the MSMS communication device may receive the SPS information over the control channel of the first subscription (e.g., the PDCCH). In some embodiments, the device processor may identify missed data packets based on some other information received over the PDCCH. In some embodiments, the device processor may calculate the data loss based on one or more missed data packets, such as one or more data packets sent to the MSMS communication device over a traffic or bearer channel (e.g., a Physical Downlink Shared Channel (PDSCH)).

The device processor may determine whether the monitor timer has expired in determination block 326. In response to determining that the monitor timer has not expired (i.e., determination block 326=“No”), the device processor may continue to monitor the control channel (e.g., PDCCH) of the first subscription in block 320.

In response to determining that the monitor timer has expired (i.e., determination block 326=“Yes”), the device processor may calculate a data loss rate in block 328. In various embodiments, the data loss rate includes an amount of data not received by the device processor during the tune-away. In some embodiments, the calculated data loss rate may serve as an indication of network conditions and/or wireless communication link conditions between the MSMS communication device and the first communication network (e.g., the communication network 102). In some embodiments, the device processor may also tune the tuned-away RF resource/Rx chain from the second subscription back to the first subscription. In some embodiments, the device processor may reset the value of the packet received counter in block 330.

In determination block 322, the device processor may determine whether the data loss rate is greater than the data loss threshold. In some embodiments, the data loss threshold may represent a maximum rate of data loss that will enable the device processor to provide a threshold level of voice communication session quality or voice communication session performance. In some embodiments, the data loss threshold may be based on a minimum throughput of data for the voice communication session that the device processor may require to provide the threshold level of voice communication session quality or voice communication session performance.

In response to determining that the data loss rate is not greater than the data loss threshold (i.e., determination block 332=“No”), the device processor may continue receiving data packets of the ongoing voice communication session in block 304.

In response to determining that the data loss rate is greater than the data loss threshold (i.e., determination block 332=“Yes”), the device processor may set the tune-away block indicator to block the next tune-away in block 334.

In determination block 336, the device processor may determine whether the voice communication session has ended. In response to determining that the voice communication session has not ended (i.e., determination block 336=“No”), the device processor may continue receiving data packets of the ongoing voice communication session in block 304. In response to determining that the voice communication session has ended (i.e., determination block 336=“Yes”), the device processor may end the method in block 338.

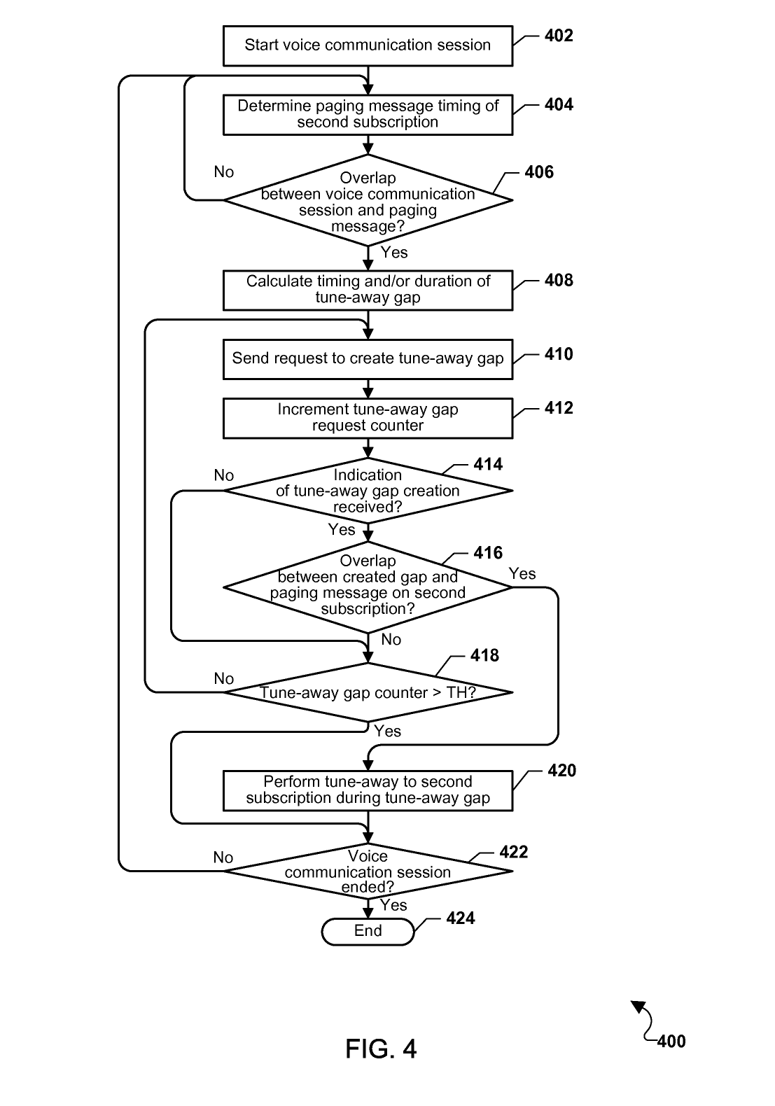

FIG. 4 illustrates a method 400 for managing a tune-away from a first subscription to a second subscription in an MSMS communication device during an ongoing voice communication session on the first subscription according to some embodiments. With reference to FIGS. 1-4, the method 400 may be implemented by a device processor (e.g., the general-purpose processor 206, the baseband processor 216, a separate controller, and/or the like) of an MSMS communication device (e.g., the MSMS communication device 102, 200).

In block 402, the MSMS communication device may start a voice communication session on a first subscription of the MSMS communication device. In some embodiments, the voice communication session may include a VoLTE communication session

In block 404, the device processor may determine a timing of paging messages on the second subscription. For example, the device processor may use system information that is received from the second network to determine the page timing of the second subscription. In some embodiments, the device processor may determine the timing of the paging messages on the second subscription while conducting the voice communication session on the first subscription. In some embodiments, the device processor may determine the timing of an upcoming communication activity on the second subscription, such as a tune-away

In determination block 406, the device processor may determine whether there is an upcoming overlap in time between the voice communication session (i.e., on the first subscription) and a paging message on the second subscription. In response to determining that there is no upcoming overlap between the first and second subscriptions (i.e., determination block 406=“No”), the device processor may determine the paging message timing of the second subscription in block 404.

In response to determining that there is an upcoming overlap between the first and second subscriptions (i.e., determination block 406=“Yes”), the device processor may calculate a timing and/or a duration of a tune-away gap in block 408. The tune-away gap may include a pause or a gap in the transmission of data to the MSMS communication device on the first subscription (e.g., for the ongoing voice communication session).

In block 410, the device processor may send a request to create the tune-away gap. For example, the device processor may send the request to a base station of the first communication network (e.g., the base station 130). In some embodiments, the device processor may use an inter-device coexistence (IDC) mechanism to request the creation of the tune-away gap. In some embodiments, the requested tune-away may include a discontinuous reception (DRX) gap. In some embodiments, the device processor may request the tune-away gap at a selected time. The selected time may be based on the calculated timing and/or duration of the tune-away gap.

In block 412, the device processor may increment a tune-away gap request counter to monitor a number of requests sent by the device processor to create the tune-away gap.

In determination block 414, the device processor may determine whether an indication of the creation of the tune-away gap is received (e.g., from the first communication network). In some embodiments, the device processor may receive an acknowledgment or another message from the first communication network indicating that the communication network will create the tune-away gap. In some embodiments, in the event that the communication network does not create the tune-away gap, the communication network may not send a notification, but rather the communication network may simply not create the tune-away gap. In some embodiments, the indication of the creation of the tune-away gap may be included in a reconfiguration message from the first communication network, for example, an RRC Reconfiguration message from a base station of the first communication network (e.g., the base station 130).

In response to determining that the indication of the creation of the tune-away gap is not received (i.e., determination block 414=“No”), the device processor may determine whether the tune-away gap counter is greater than a threshold number of tune-away gap requests, in determination block 418. In response to determining that the tune-away gap counter is not greater than the threshold number of tune-away gap requests (i.e., determination block 418=“No”), the device processor may send another request to create the tune-away gap in block 410.

In response to determining that the indication of the creation of the tune-away gap is received (i.e., determination block 414=“Yes”), the device processor may determine whether there is an upcoming overlap in time between the created gap and a paging message on the second subscription in determination block 416.

In response to determining that there is an upcoming overlap in time between the created gap and the paging message on the second subscription (i.e., determination block 416=“Yes”), the device processor may perform the tune-away to the second subscription during the tune-away gap in block 420.

In response to determining that there is no upcoming overlap in time between the created gap and the paging message on the second subscription (i.e., determination block 416=“No”), the device processor may determine whether the tune-away gap counter is greater than a threshold number of tune-away gap requests in determination block 418.

In response to determining that tune-away gap counter is not greater than a threshold number of tune-away gap requests (i.e., determination block 418=“No”), the device processor may repeat the operations of sending a request to create a tune-away gap in block 410 as described.

In response to determining that tune-away gap counter is greater than the threshold number of tune-away gap requests (i.e., determination block 418=“No”) or after performing a tune-away to the second subscription during a tune-away gap in block 420, the device processor may determine whether the voice communication session has ended in determination block 422. In response to determining that the voice communication session has ended (i.e., determination block 422=“Yes”), the device processor may end the method in block 424.

In response to determining that the voice communication session has not ended (i.e., determination block 422=“No”), the device processor may again determine a paging message timing of the second subscription in block 402.

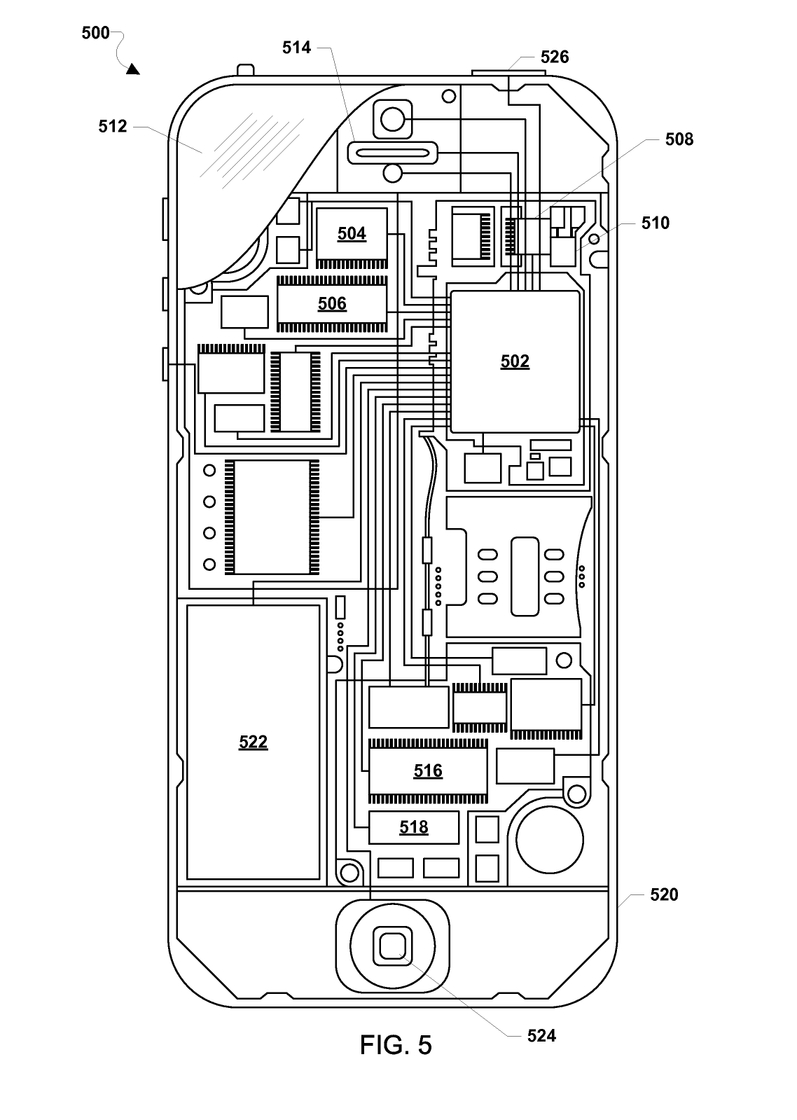

Various embodiments (including, but not limited to, embodiments described with reference to FIGS. 1-4) may be implemented in any of a variety of multi-subscription multi-standby communication devices, an example of which (e.g., multi-subscription multi-standby communication device 500) is illustrated in FIG. 5. With reference to FIGS. 1-4, in various embodiments, the multi-subscription multi-standby communication device 500 (which may correspond, for example, to the multi-subscription multi-standby communication devices 110 and 200 in FIGS. 1 and 2) may include a processor 502 coupled to a touchscreen controller 504 and an internal memory 506. The processor 502 may be one or more multi-core integrated circuits designated for general or specific processing tasks. The internal memory 506 may be volatile or non-volatile memory, and may also be secure and/or encrypted memory, or unsecure and/or unencrypted memory, or any combination thereof. The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the multi-subscription multi-standby communication device 500 need not have touch screen capability.

The multi-subscription multi-standby communication device 500 may have two or more radio signal transceivers 508 (e.g., Peanut, Bluetooth, ZigBee, Wi-Fi, RF radio) and antennae 510, for sending and receiving communications, coupled to each other and/or to the processor 502. The transceivers 508 and antennae 510 may be used with the above-mentioned circuitry to implement the various wireless transmission protocol stacks and interfaces. The multi-subscription multi-standby communication device 500 may include one or more cellular network wireless modem chip(s) 516 coupled to the processor and antennae 510 that enables communication via two or more cellular networks via two or more radio access technologies.

The multi-subscription multi-standby communication device 500 may include a peripheral device connection interface 518 coupled to the processor 502. The peripheral device connection interface 518 may be singularly configured to accept one type of connection, or may be configured to accept various types of physical and communication connections, common or proprietary, such as USB, FireWire, Thunderbolt, or PCIe. The peripheral device connection interface 518 may also be coupled to a similarly configured peripheral device connection port (not shown).

The multi-subscription multi-standby communication device 500 may also include speakers 514 for providing audio outputs. The multi-subscription multi-standby communication device 500 may also include a housing 520, constructed of a plastic, metal, or a combination of materials, for containing all or some of the components discussed herein. The multi-subscription multi-standby communication device 500 may include a power source 522 coupled to the processor 502, such as a disposable or rechargeable battery. The rechargeable battery may also be coupled to the peripheral device connection port to receive a charging current from a source external to the multi-subscription multi-standby communication device 500. The multi-subscription multi-standby communication device 500 may also include a physical button 524 for receiving user inputs. The multi-subscription multi-standby communication device 500 may also include a power button 526 for turning the multi-subscription multi-standby communication device 500 on and off.

The processor 502 may be any programmable microprocessor, microcomputer or multiple processor chip or chips that can be configured by software instructions (applications) to perform a variety of functions, including the functions of various embodiments described below. In some multi-subscription multi-standby communication devices, multiple processors 502 may be provided, such as one processor dedicated to wireless communication functions and one processor dedicated to running other applications. Typically, software applications may be stored in the internal memory 506 before they are accessed and loaded into the processor 502. The processor 502 may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the method 300 may be substituted for or combined with one or more operations of the method 400, and vice versa.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of various embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, various embodiments are not intended to be limited to the embodiments shown herein but are to be accorded the widest scope consistent with the following claims and the principles and novel features disclosed herein.

What is claimed is:

1. A method for managing a tune-away from a first subscription to a second subscription in a multi-subscription multi-standby communication device during an ongoing voice communication session on the first subscription, the method comprising:
performing a tune-away from the first subscription to the second subscription;
determining whether data was transmitted to the multi-subscription multi-standby communication device over the first subscription during the tune-away;
calculating a data loss rate in response to determining that data was transmitted to the multi-subscription multi-standby communication device over the first subscription during the tune-away;
determining whether the data loss rate is greater than a data loss threshold; and
blocking a next tune-away in response to determining that the data loss rate is greater than the data loss threshold.

2. The method of claim 1, further comprising:
permitting a next tune-away in response to determining that the data loss rate is not greater than the data loss threshold.

3. The method of claim 1, further comprising:
monitoring a control channel of the first subscription during the tune-away,
wherein determining whether data was transmitted to the multi-subscription multi-standby communication device over the first subscription during the tune-away is based on the monitoring of the control channel of the first subscription.

4. The method of claim 1, wherein blocking a next tune-away in response to determining that the data loss rate is greater than the data loss threshold comprises:
setting a tune-away block indicator to block the next tune-away in response to determining that the data loss rate is greater than the data loss threshold.

5. The method of claim 4, further comprising:
determining whether the tune-away block indicator is set to block the next tune-away; and
blocking the next tune-away in response to determining that the tune-away block indicator is set to block the next tune-away.

6. A method for managing a tune-away from a first subscription to a second subscription in a multi-subscription multi-standby communication device during a voice communication session on the first subscription, the method comprising:
determining a paging message timing of the second subscription;
determining whether there is an upcoming overlap between the voice communication session and a paging message on the second subscription;
calculating a timing of a tune-away gap;
sending a request using the first subscription to create the tune-away gap; and
performing a tune-away from the first subscription to the second subscription during the tune-away gap.

7. The method of claim 6, wherein calculating a timing of a tune-away gap further comprises calculating a duration of the tune-away gap.

8. The method of claim 6, further comprising:
determining whether an indication of a creation of the tune-away gap is received; and
determining whether there is an upcoming overlap between the tune-away gap and a paging message on the second subscription,
wherein performing the tune-away from the first subscription to the second subscription during the tune-away gap comprises performing the tune-away from the first subscription to the second subscription during the tune-away gap in response to determining that there is an upcoming overlap between the tune-away gap and a paging message on the second subscription.

9. The method of claim 6, further comprising:
incrementing a tune-away gap request counter after sending the request using the first subscription to create the tune-away gap.

10. The method of claim 9, further comprising:
determining whether the tune-away gap request counter is greater than a tune-away gap counter threshold; and
sending another request to create the tune-away gap in response to determining that the tune-away gap request counter is not greater than the tune-away gap counter threshold.

11. A multi-subscription multi-standby communication device, comprising:
a memory;
a radio frequency resource; and
a processor coupled to the memory and the radio frequency resource and configured with processor-executable instructions to:
perform a tune-away from a first subscription to a second subscription during an ongoing voice communication session on the first subscription;
determine whether data was transmitted to the multi-subscription multi-standby communication device over the first subscription during the tune-away;
calculate a data loss rate in response to determining that data was transmitted to the multi-subscription multi-standby communication device over the first subscription during the tune-away;
determine whether the data loss rate is greater than a data loss threshold; and
block a next tune-away in response to determining that the data loss rate is greater than the data loss threshold.

12. The multi-subscription multi-standby communication device of claim 11, wherein the processor is further configured with processor-executable instructions to:
permit a next tune-away in response to determining that the data loss rate is not greater than the data loss threshold.

13. The multi-subscription multi-standby communication device of claim 11, wherein the processor is further configured with processor-executable instructions to:
monitor a control channel of the first subscription during the tune-away; and
determine whether data was transmitted to the multi-subscription multi-standby communication device over the first subscription during the tune-away based on the monitoring of the control channel of the first subscription.

14. The multi-subscription multi-standby communication device of claim 11, wherein the processor is further configured with processor-executable instructions to:
set a tune-away block indicator to block the next tune-away in response to determining that the data loss rate is greater than the data loss threshold.

15. The multi-subscription multi-standby communication device of claim 14, wherein the processor is further configured with processor-executable instructions to:
determine whether the tune-away block indicator is set to block the next tune-away; and
block the next tune-away in response to determining that the tune-away block indicator is set to block the next tune-away.

16. A multi-subscription multi-standby communication device, comprising:
a memory;
a radio frequency resource; and
a processor coupled to the memory and the radio frequency resource and configured with processor-executable instructions to:
determine a paging message timing of a second subscription;
determine whether there is an upcoming overlap between an ongoing voice communication session on a first subscription and a paging message on the second subscription;
calculate a timing of a tune-away gap;
send a request using the first subscription to create the tune-away gap; and
perform a tune-away from the first subscription to the second subscription during the tune-away gap.

17. The multi-subscription multi-standby communication device of claim 16, wherein the processor is further configured with processor-executable instructions to calculate a duration of the tune-away gap.

18. The multi-subscription multi-standby communication device of claim 16, wherein the processor is further configured with processor-executable instructions to:
determine whether an indication of a creation of the tune-away gap is received;
determine whether there is an upcoming overlap between the tune-away gap and a paging message on the second subscription; and
perform the tune-away from the first subscription to the second subscription during the tune-away gap in response to determining that there is an upcoming overlap between the tune-away gap and a paging message on the second subscription.

19. The multi-subscription multi-standby communication device of claim 16, wherein the processor is further configured with processor-executable instructions to:
increment a tune-away gap request counter after sending the request using the first subscription to create the tune-away gap.

20. The multi-subscription multi-standby communication device of claim 19, wherein the processor is further configured with processor-executable instructions to:
determine whether the tune-away gap request counter is greater than a tune-away gap counter threshold; and
send another request to create the tune-away gap in response to determining that the tune-away gap request counter is not greater than the tune-away gap counter threshold.
